(19) United States
(12) Patent Application Publication
(10) Pub. No.: US 2024/0002176 A1
(43) Pub. Date: Jan. 4, 2024

(54) LOADING RAMP WITH INSULATION

(71) Applicant: HÖRMANN ALKMAAR BV, Alkmaar (NL)

(72) Inventors: Volker VERHULST, Heerhugowaard (NL); Franciscus Johannes STROET, Heerhugowaard (NL)

(21) Appl. No.: 18/253,191

(22) PCT Filed: Nov. 17, 2021
(86) PCT No.: PCT/NL2021/000014

§ 371 Date: May 16, 2023

(30) Foreign Application Priority Data
Nov. 19, 2020 (NL) 1043848

(51) Int. Cl. B65G 69/28

(52) U.S. Cl. CPC B65G 69/2811; B65G 69/287

(57) ABSTRACT

Loading ramp for loading platforms, including a bridge plate which at its loading platform side rotatably is connected to the loading platform and at its front side is provided with a lip, which lip, from a retracted position, in which the lip is taken up underneath the bridge plate, is extendible from the front side of the bridge plate forward into an extended position, in which extended position a foremost lip part, being provided to the front side of the lip, is intended to rest upon the loading floor of a vehicle, whereby underneath the bridge plate, completely or partly, a layer of insulating material is provided, wherein in the extended position underneath the lip a further layer of insulating material is present.

The present invention relates to a loading ramp, comprising a bridge plate which at its loading platform side rotatably is connected to the loading platform and at its front side is provided with a lip, which lip, from a retracted position, in which the lip is taken up underneath or in the bridge plate, is extendible out of the front side of the bridge plate forward into an extended position, in which extended position a foremost lip part, being provided to the front side of the lip, is intended to rest upon the loading floor of a vehicle, whereby underneath the bridge plate completely or partly a layer of insulating material is provided.

Such a loading ramp is known.

A loading ramp is a provision near or in the hall of a building, for example a distribution centre, where a truck can load and unload. The loading ramp comprises a platform with a bridge plate therein. Often the platform with the bridge plate is taken up inside the hall of the building. To that end the building is provided with a recess so that there is a space in which the bridge plate can be turned upwards and downwards to bridge a difference in height between the floor in the building and the floor of the truck.

During the loading and unloading air flows develop between the inside and the outside and warmth can escape from the building.

Among other for this reason in practice one provides a loading ramp with a shelter. This provides a water- and windproof separation between the back side of the loading space of the truck and the front opening in the façade of the building into which the cargo from the truck has to be transferred. The sides and the roof of the shelter are covered with a cloth, and enclose the sides and the roof at the back side of the truck.

However, during loading and unloading the space in the building underneath the loading ramp still is in direct contact with the air outside.

Because of this with a known loading ramp a fixed panel is mounted on to the bottom of the frame of the loading ramp for insulation. Further, in the front underneath the bridge plate also a fixed panel is mounted. Between these two insulation panels a moving panel is provided. This moving panel hinges at its upper edge to the panel that is provided in the front underneath the bridge plate, and slides or rolls at its lower edge over the panel that is provided on to the bottom of the frame.

A drawback of this is, that the insulation that is provided at the bottom in the loading ramp horizontally does not connect well to the insulation of the floor of the building, which generally is provided directly underneath the floor in the building, the floor having a thickness of 150-250 mm.

To obviate this latter drawback in practice one has proceeded to positioning the insulation, instead of onto the frame beneath the loading ramp, upwards on to the bottom side of the bridge plate. In practice this insulation connects better to the insulation of the floor in the building.

A drawback that still exists with this known loading ramp is that the lip is not insulated when this is extended. The known lip comprises slits through which air flows are possible; the absence of an insulation underneath the lip generates a lot of thermic flow from the bottom side.

It is an object of the invention to obviate this drawback of the known loading ramp.

The loading ramp according to the invention to that end is characterized, in that means are provided by way of which in the extended position underneath the lip a further layer of insulating material is present.

According to a characteristic of the loading ramp according to the invention the means are formed in that the loading ramp is provided with a holder from which, with a sliding out of the lip from the retracted position to the extended position, a flexible insulating material can be rolled off or folded out by the lip at the bottom side thereof and can be pulled along with the lip.

According to another characteristic of the loading ramp according to the invention the means are formed in that the first layer of insulating material is formed by a first insulating panel, while above this first insulating panel and underneath the lip a second insulating panel is present, which second insulating panel is movable relative to the first insulating panel, and means are provided by way of which, with a sliding out to the front of the lip from the retracted position to the extended position, the second insulating panel is pulled along.

According to a further characteristic of the loading ramp according to the invention the means by which, with a sliding out of the lip, the second insulating panel is pulled along, are formed by a catch provided underneath and at the front side of the lip, and an upwards standing part provided at the front side of the second insulating panel, in such a way, that with a sliding out of the lip, the catch lands against the upwards standing part on the second insulating panel and takes this along during the sliding out.

According to another characteristic of the loading ramp according to the invention underneath the bridge plate a beam is provided, extending transverse to the direction of movement of the lip, which beam limits the path of movement backwards of the second insulating panel, in such a way, that the second insulation panel in the retracted position lies with its rear edge against this beam.

According to another characteristic of the loading ramp according to the invention the front edge of the second insulating panel is provided with a strip protruding downwards, which strip in the retracted position lies draught sealingly against the upper side of the first insulating panel.

Further characteristics and particulars of the loading ramp according to the invention will be explained with reference to the drawings of an example of an embodiment.

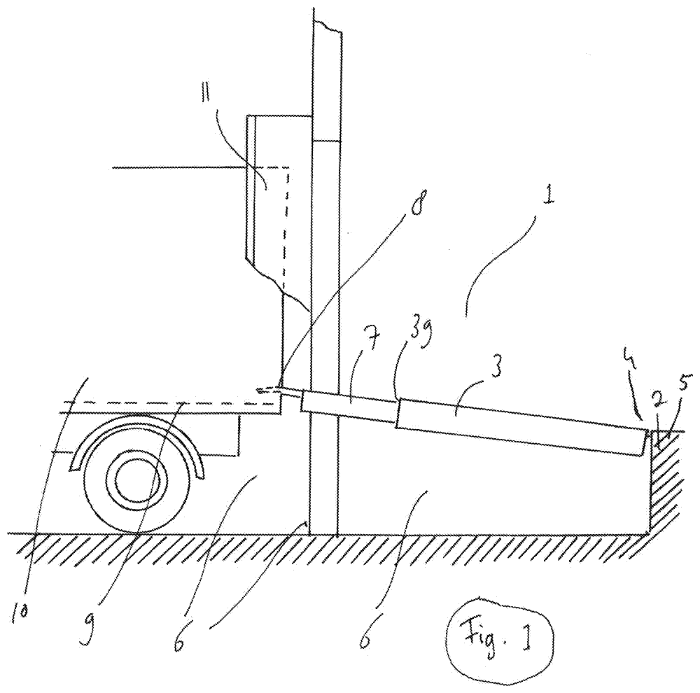

FIG. 1 shows a side view of a known loading ramp with a truck that is parked at the front opening in the façade of the building.

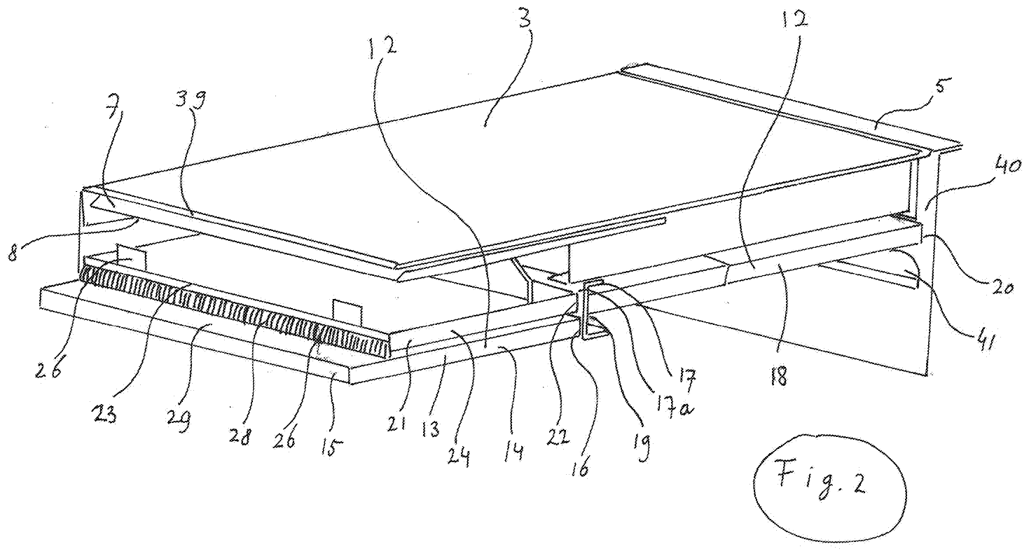

FIG. 2 shows a perspective view of a loading ramp according to the invention whereby the lip is retracted underneath the bridge plate.

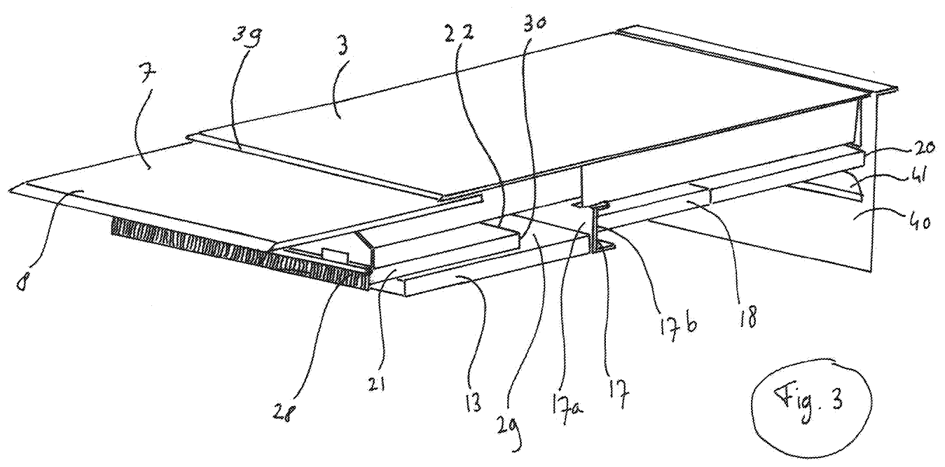

FIG. 3 shows a perspective view of the loading ramp of FIG. 2 with a lip extended to the front.

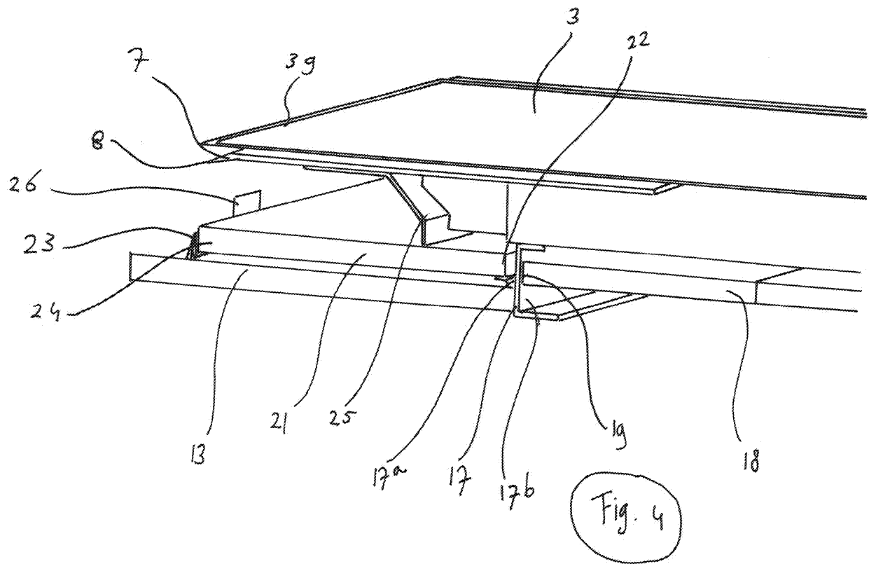

FIG. 4 shows a perspective view from another position of the loading ramp according to the FIGS. 2 and 3, with retracted lip.

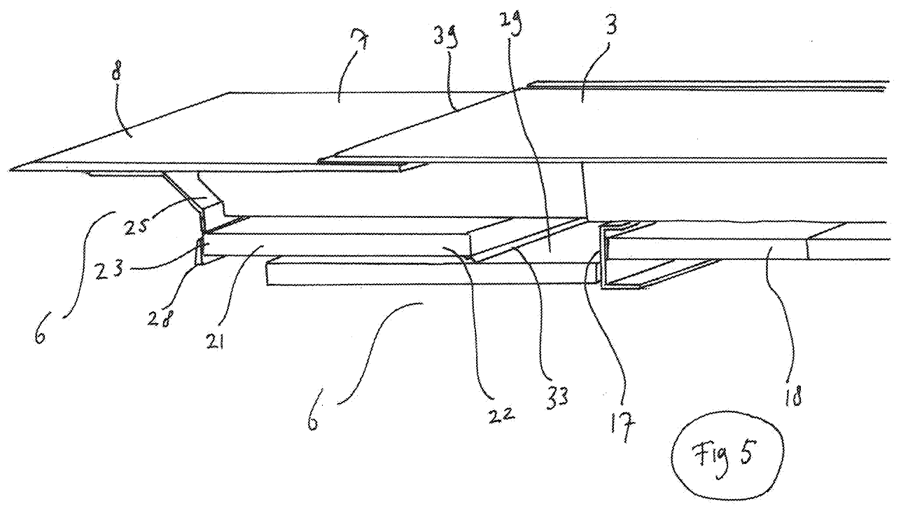

FIG. 5 shows a perspective view of the loading ramp according to FIG. 4 with extended lip.

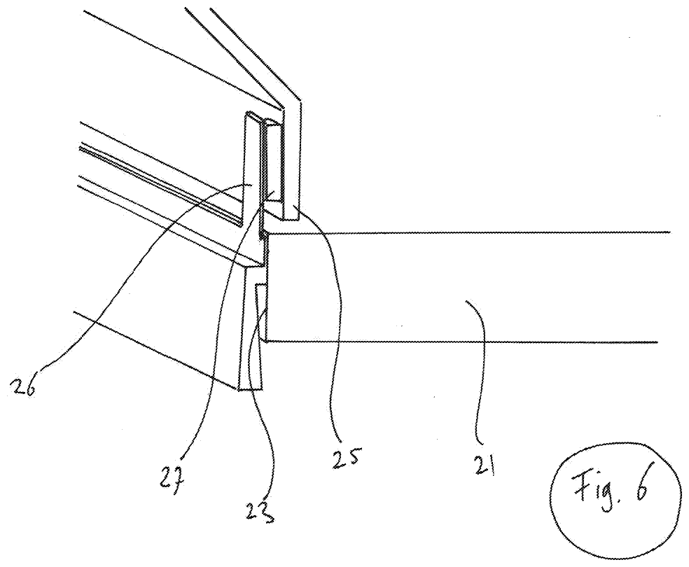

FIG. 6 shows a detail of a loading ramp according to the invention.

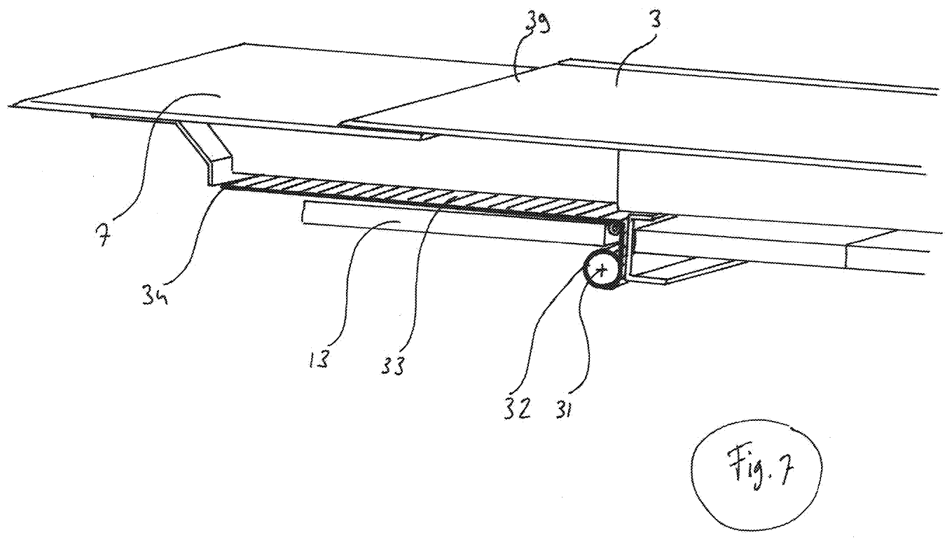

FIG. 7 shows a further example of an embodiment of the loading ramp according to the invention.

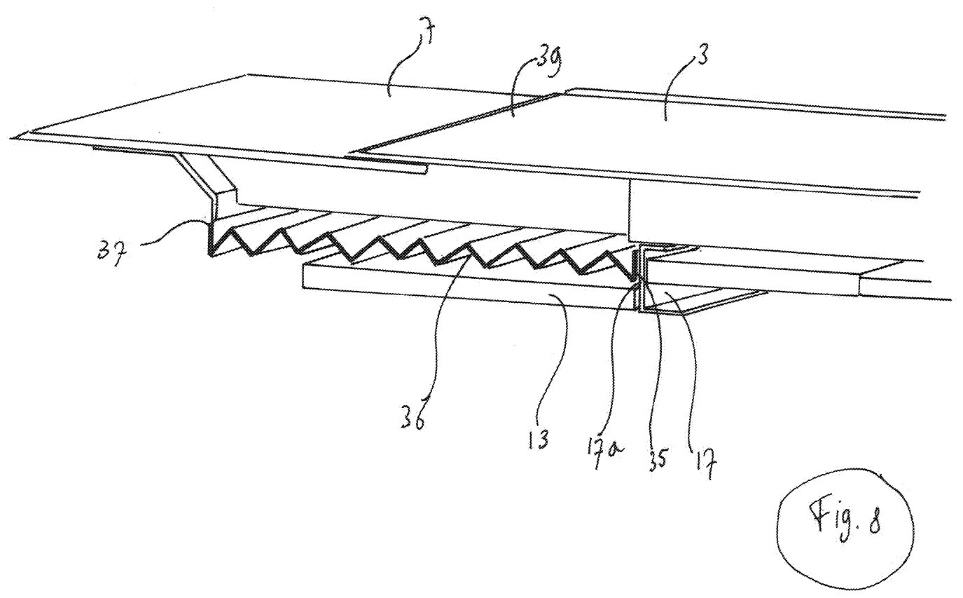

FIG. 8 shows a yet further example of an embodiment of the loading ramp according to the invention.

As can be seen in FIG. 1, the known loading ramp 1 in the hall 2 of a building comprises a bridge plate 3 which at its loading platform side 4 rotatably is connected to the loading platform 5. There is a recess so that there is a space 6 in which the bridge plate 3 can be turned upwards and downwards. This space 6 is in connection with the surroundings outside the building 2. At the front side 39 the bridge plate 3 is provided with a retractable and extendable lip 7. This lip 7 is provided with a foremost lip part 8 that is intended to rest upon the loading floor 9 of a truck. 10. In FIG. 1 part of a shelter 11 is shown, whereby the bottom part has been left out.

In the FIGS. 2, 3, 4 and 5 an example of an embodiment of the loading ramp according to the invention is shown. There underneath the bridge plate 3 a layer of insulating material 12 is provided.

In the example of an embodiment shown the layer of insulating material is formed by a first insulating panel 13, that is fixedly provided at the front underneath the bridge plate 3 and the lip 7. In the example of an embodiment shown the first insulating panel 13 has two side edges 14, a front edge 15 and a rear edge 16. The first insulating panel 13 lies with its rear edge 16 against a side 17a of a beam 17 that runs on underneath the bridge plate 3 and the lip 7, transverse to the direction of movement of the lip 7. The first insulating panel lies fixed.

In the FIGS. 2, 3, 4 and 5 it can further be seen that backwards in the direction of the loading platform 5, underneath the bridge plate 3 a further insulating panel 18 is provided, that lies with a front edge 19 against the other side 17b of the beam 17 and continues towards the platform with the rear edge 20 towards close to the connection of the bridge plate 3 to the frame 40 at the platform 5. Between the panel 18 and the frame 40 a sealing flexible flap 41 is provided.

As can further be seen in the FIGS. 2, 3, 4, and 5 at the front underneath the bridge plate 3 and the lip 7, on top of the first insulating panel 13 and underneath the lip 7 a second insulating panel 21 is present, with a rear edge 22, a front edge 23 and two side edges 24. The second insulating panel 21 is slidable or glideable to the front relative to the first insulating panel 13.

At the front underneath the lip 7 (the FIGS. 4 and 5) a catch is provided in the form of a downwardly protruding edge 25, while at the front edge 23 of the second insulating panel 21 one or more upwardly standing parts, in this example of an embodiment one or more upwardly protruding plates 26, are provided. When the lip 7 is extended to the front the catch 25 lands against the plates 26. In this manner the second insulating panel 21, when the lip 7 slides out further, is taken or pushed along to the front by the lip 7 (FIG. 5).

With this it is achieved, that when the lip 7 is extended and is present in the space 6, to which the outside air has access, that there will be no transfer of cold by air flows to the inside through slits present in the lip 7, or transfer of cold by a cooling off of the metal of the lip 7 and a subsequent giving off by the lip 7 of the cold to the surroundings within the housing around the loading ramp. Other holes and cracks are sealed by draught strips or draught brushes.

Further there is a provision by means of which, when the lip 7 is retracted again, the second insulating panel 21 will move along backwards.

When the lip 7 and the second insulating panel 21 are extended the catch 25 underneath the lip 7 rests against the plate or plates 26 on the second insulating panel 21. The catch 25 or the plates 26 are provided with one or more magnets 27, shown in detail in FIG. 6.

When the lip is retracted the magnets 27 cause the second insulating panel 21 to be taken along backwards. With the sliding in of the lip 7 and the moving along backwards of the insulating panel 21 the panel 21 at some moment bumps, with its rear side 22, against the side 17a of the beam 17, and whereby the beam 17 blocks the further movement of the insulating panel 21, and after which the lip 7 without the panel 21 slides in further underneath the bridge plate 3.

Further, the rear edge 22 of the second insulating panel 21 or the side 17a of the beam 17 facing the second insulating panel is provided with one or more magnets (not shown in the drawings). By this it is avoided that the second insulating panel 21 inadvertently, under the gravity, slides forward when the bridge plate 3 with the lip 7 slopes downwards, or, if the lip 7 or the panel 21 were to get dirty or deform, the panel 21 at the smallest friction slides along forward the moment the lip is moved to the front (and whereby the panel might be damaged because this protrudes too much forward).

In the shown example of an embodiment the front edge 23 of the second insulating panel 21 is provided with a downwardly directed protruding strip 28, such as a draught sealing or dirt skimmer, which strip 28 in the retracted (position) lies sealingly against the upper side 29 of the first insulating panel 13.

In the same way the rear edge 22 of the second insulating panel 21 is provided with an equal downwardly directed protruding strip 30, which in the retracted position and in the extended position lies sealingly against the top side 29 of the first insulating panel 13.

In a favourable manner to that end the distance between the front edge 15 and the rear edge 16 of the first insulating panel 13 is larger than that between the front edge 23 and the rear edge 22 of the second insulating panel 21.

In FIG. 7 a further example of an embodiment of the loading ramp according to the invention is shown. In this example instead of a panel underneath the lip 7 a roll 31 is provided on to which an outer end 32 of a strip 33 of insulating flexible material is fastened, and around which this is rolled up. The other outer end 34 of the strip of material 33 is connected to the lip. With a sliding out forwards of the lip 7 the strip of material 33 is unrolled and is taken along forwards to the front by the lip 7 at the bottom side thereof. In a known manner the roll 31 can be provided with a spring mechanism by means of which the strip 33 with a sliding in of the lip 7 is rolled up.

In FIG. 8 still a further embodiment is shown, whereby an outer end 35 of a flexible insulating strip 36 of material, folded up in accordion shape, is fastened to the side 17a of the beam 17. The other outer end 37 is connected to the lip 7. With a sliding out of the lip 7 the strip 36 of material is folded open and taken along at the bottom side.

1. Loading ramp for loading platforms, comprising a bridge plate which at its loading platform side rotatably is connected to the loading platform and at its front side is provided with a lip, which lip, from a retracted position, in which the lip is taken up underneath the bridge plate, is extendible from the front side of the bridge plate forward into an extended position, in which extended position a foremost lip part, being provided to the front side of the lip, is intended to rest upon the loading floor of a vehicle, whereby underneath the bridge plate, completely or partly, a layer of insulating material is provided, characterized in that means are provided by way of which in the extended position underneath the lip a further layer of insulating material is present.

2. Loading ramp according to claim 1, wherein the means are formed in that the loading ramp is provided with a holder from which, with a sliding out of the lip from the retracted position to the extended position, by the lip a flexible insulating material can be rolled off or folded out at the bottom side and can be pulled along with the lip at the bottom side thereof.

3. Loading ramp according to claim 1, wherein the means are formed in that the first layer of insulating material is formed by a first insulating panel, while above this first insulating panel and underneath the lip a second insulating panel is present, which second insulating panel is movable relative to the first insulating panel, and means are provided by way of which, with a sliding out of the lip from the retracted position to the extended position, the second insulating panel is pulled along to the front.

4. Loading ramp according to claim 3, wherein the means by which with a sliding out of the lip the second insulating panel is pulled along to the front, are formed by a catch provided underneath and at the front side of the lip, and an upward standing part provided at the front side of the second insulating panel, in such a way, that with a sliding out of tire lip to the front, the catch lands against the upwards standing part and takes the second insulating panel along during the sliding out to the front.

5. Loading ramp according to claim 3, wherein the catch or the upwards standing part is provided with one or more magnets.

6. Loading ramp according to claim 3, wherein underneath the bridge plate a beam is provided, extending transverse to the direction of movement of the lip, which beam limits the path of movement backwards of the second insulating panel, in such a way, that the second insulation panel in the retracted position lies with its rear edge against this beam.

7. Loading ramp according to claim 6, wherein the rear edge of the second insulating panel or the side of the beam lacing the second insulating panel is provided with one or more magnets.

8. Loading ramp according to claim 3, wherein the first insulation panel comprises a rear edge, a front edge and two side edges and the second insulating panel comprises a rear edge, a front edge and two side edges, whereby the distance between the front edge and the rear edge of the first insulating panel is larger than that between the front edge and the rear edge of the second insulating panel.

9. Loading ramp according to claim 3, wherein the second insulating panel in de retracted position rests on the first insulating panel.

10. Loading ramp according to claim 3, wherein the front edge of the second insulating panel is provided with a strip protruding downwards, which strip in the retracted position lies sealingly against tire upper side of the first insulating panel.

11. Loading ramp according to claim 3, wherein the rear edge of the second insulating panel is provided with a strip protruding downwards, which strip in the retracted position and in the extended position lies sealingly against the upper side of the first insulating panel.
